(19) United States
(12) Patent Application Publication
(10) Pub. No.: US 2013/0265391 A1
(43) Pub. Date: Oct. 10, 2013

(54) DISPLAY DEVICE AND METHOD FOR AUTOMATICALLY ADJUSTING THE BRIGHTNESS OF AN IMAGE ACCORDING TO THE IMAGE MODE

(71) Applicant: Jin Hwan Lee, Daejeon (KR)

(72) Inventor: Jin Hwan Lee, Daejeon (KR)

(73) Assignee: Electronics and Telecommunications Research Institute, Daejeon (KR)

(21) Appl. No.: 13/994,634

(22) PCT Filed: Dec. 7, 2011
(86) PCT No.: PCT/KR2011/009402

§ 371 Date: Jun. 14, 2013

(30) Foreign Application Priority Data
Dec. 17, 2010 (KR) 10-2010-0130203

(51) Int. Cl. H04N 9/77; H04N 13/04

(52) U.S. Cl. CPC H04N 9/77; H04N 13/04
USPC 348/43; 348/687

(57) ABSTRACT

Disclosed is a display device and method for automatically adjusting the brightness of an image according to the image mode. The display device includes: a determination unit for obtaining information relating to an input image and determining the image mode of the input image on the basis of the obtained information; a converting unit for receiving the input image and automatically adjusting the brightness of the input image according to the image mode determined by the determination unit; and a display unit for displaying the image outputted from the converting unit. Accordingly, the image mode of an image is determined, and the brightness of the image is automatically adjusted, and in particular, the brightness of the image in 3D mode is adjusted automatically so that the user may watch a 3D image with a high level of satisfaction without additional settings.

### TECHNICAL FIELD

The present invention relates to a display device and a display method for automatically adjusting brightness of a video according to a video mode, and more particularly, to a display device and a display method capable of determining a video mode of an input video and converting brightness of a video to be appropriate for the determined video mode.

### BACKGROUND ART

Generally, a three-dimensional (3D) display means a display capable of providing a three-dimensional effect to users by dividing a left side video and a right side video from contents including left/right side video information and transferring the left side video to a left eye and the right side video to a right eye.

The 3D display type may be mainly divided into a space division type and a time division type according to a technology of dividing a 3D video. In the space division type, the left/right side videos of a single picture are simultaneously displayed. The displayed left and right side videos are divided by a physical device, for example, glasses, a panel, or the like, to arrive at each of the left/right eyes. The space division type may also be referred to as a polarizing filter type.

On the other hand, in the time division type, a picture of the left side video and a picture of the right side video are alternately displayed, having a time difference therebetween, and the respective videos are divided by the physical device such as the glasses, or the like, to arrive at the left eye or the right eye. The time division type may also be referred to as a shutter glasses type.

Meanwhile, a recent 3D display device is generally manufactured for both 2D and 3D. The combined 2D/3D display device divides and displays the picture of the left side video and the picture of the right side video in the case in which it displays the 3D video.

However, when the user views the 3D video using the combined 2D/3D display device, he or she should use the physical device such as glasses, or the like. Therefore, the user views a screen darker than an original video screen. Accordingly, brightness of the video felt by the user is significantly reduced when the user views the 3D video than when he or she views the 2D video. Due to this reason, quality of the video felt by the user can not but be significantly degraded.

In the case of a display device currently used, generally, the user manually adjusts the brightness of a screen of the display device by using a user menu according to a video mode of a displayed video. For example, when the user feels that the screen is dark during display of the 3D video, he or she loads the user menu to make the brightness of the display screen bright.

However, in this case, the user should individually adjust the brightness of the screen of the display device according to whether the video displayed on the display device is the 2D video or the 3D video. This inconvenience has been pointed out as a problem that may cause deterioration of a satisfaction of 3D contents service.

### DISCLOSURE

### Technical Problem

The present invention provides a display device and a display method for automatically adjusting brightness of a video according to a video mode capable of determining a video mode of an input video and adjusting the brightness of the video to appropriate brightness according to the determined video mode.

### Technical Solution

In an aspect, there is provided a display device including: a determining unit obtaining information associated with an input video and determining a video mode of the input video based on the obtained information; a converting unit receiving the input video and automatically converting brightness of the input video according to the video mode determined by the determining unit; and a display unit displaying a video output from the converting unit.

The determining unit may determine a 3D video format of the input video based on the obtained information when the video mode of the input video is a 3D mode.

The converting unit may include: a brightness converter converting the brightness of the input video to be bright based on preset brightness conversion information when it is determined by the determining unit that the video mode of the input video is the 3D mode; and a 3D video converter converting the input video into a video having a 3D video format corresponding to a display type of the display unit based on the 3D video format of the input video determined by the determining unit.

The converting unit may include: a 3D video converter converting the input video into a video having a 3D video format corresponding to a display type of the display unit based on the 3D video format of the input video determined by the determining unit when it is determined by the determining unit that the video mode of the input video is the 3D mode; and a brightness converter converting the brightness of the input video converted by the 3D video converter to be bright based on preset brightness conversion information when it is determined by the determining unit that the video mode of the input video is the 3D mode.

The converting unit may convert the video having the 3D video format determined by the determining unit to a video having a line alternative format when the display type of the display unit is a polarizing filter type.

The converting unit may convert the video having the 3D video format determined by the determining unit into a video having any one of a field alternative format and a frame alternative format when the display type of the display unit is a shutter glasses type.

The determining unit may include at least any one of: a first determining unit determining the video mode and a 3D video format by interpreting received 3D signaling information such as a video signal input from an external device; a second determining unit determining the video mode and the 3D video format by interpreting 3D signaling information included in a digital broadcasting signal; and a third determining unit determining the video mode and the 3D video format according to information input from a user interface.

The first determining unit may determine the video mode of the input video by interpreting an ‘HDMI Video Format’ field of a ‘Vendor Specific InfoFrame’ packet included in a high definition multimedia interface (HDMI) signal, and determines the 3D video format of the input video by interpreting a ‘3D_Structure’ field when the input video is the 3D mode video.

The second determining unit may determine the video mode and the 3D video format of the input video by interpreting information on a video mode and a 3D video format included in at least any one of program map table (PMT), ‘user_data’ and supplemental enhancement information (SEI) of the digital broadcasting signal.

In another aspect, there is provided a display method including: obtaining information associated with an input video; determining a video mode of the input video based on the obtained information; automatically converting brightness of the input video according to the determined video mode; and displaying a display video based on the brightness-converted video.

The display method may further include determining a 3D video format of the input video based on the obtained information when it is determined that the video mode of the input video is a 3D mode at the determining.

The display method may further include converting the input video into a video having a 3D video format corresponding to a display type of the display unit based on the determined 3D video format of the input video. In this case, the automatic converting of the brightness of the input video may include: converting the brightness of the input video to be bright based on preset brightness conversion information when it is determined that the video mode of the input video is the 3D mode at the determining.

The display method may further include converting the input video into a video having a 3D video format corresponding to a display type of the display unit based on the determined 3D video format of the input video when it is determined that the video mode of the input video is the 3D mode at the determining. In this case, the automatical converting of the brightness of the input video may include: converting the brightness of the input video converted into the video having the 3D video format corresponding to the display type to be bright based on preset brightness conversion information.

The determining may include at least any one of: determining the video mode and a 3D video format by interpreting received 3D signaling information such as a video signal input from an external device; determining the video mode and the 3D video format by interpreting 3D signaling information included in a digital broadcasting signal; and determining the video mode and the 3D video format according to information input from a user interface.

The determining of the video mode and the 3D video format by interpreting the received 3D signaling information such as the video signal input from the external device may include: determining the video mode of the input video by interpreting an ‘HDMI Video Format’ field of a ‘Vendor Specific InfoFrame’ packet included in an HDMI signal; and determining the 3D video format of the input video by interpreting a ‘3D_Structure’ field when the input video is the 3D mode video.

The determining of the video mode and the 3D video format by interpreting the 3D signaling information included in the digital broadcasting signal includes: determining the video mode and the 3D video format of the input video by interpreting information on a video mode and a 3D video format included in at least any one of PMT, ‘user_data’ and SEI of the digital broadcasting signal.

### Advantageous Effects

As described above, according to the exemplary embodiment of the present invention, the video mode of the input video may be determined and the brightness of the video may be automatically converted according to the determined video mode. Particularly, in the 3D mode video, the brightness of the video may be automatically adjusted to be bright. As a result, the user may view the 3D video while having a high satisfaction without performing a separate setting.

### DESCRIPTION OF DRAWINGS

FIG. 1 is a block diagram showing a configuration of a display device according to a first exemplary embodiment of the present invention.

FIG. 2 is a flowchart showing a configuration of a 3D display method according to a first exemplary embodiment of the present invention.

FIG. 3 is a block diagram showing a configuration of a display device according to a second exemplary embodiment of the present invention.

FIG. 4 is a flowchart for describing an operation flow of the display device shown in FIG. 3.

### MODE FOR INVENTION

Hereinafter, exemplary embodiments of the present invention will be described in detail with reference to the accompanying drawings so that technical content of the present invention can be easily understood by those skilled in the art to which the present invention pertains. In the exemplary embodiments of the present invention described below, specific technical terminologies are used for clarity of content. However, the present invention is not limited to the selected specific terminologies. It should be understood that each of the specific terminologies includes all technical synonyms having similar meaning for accomplishing a similar object.

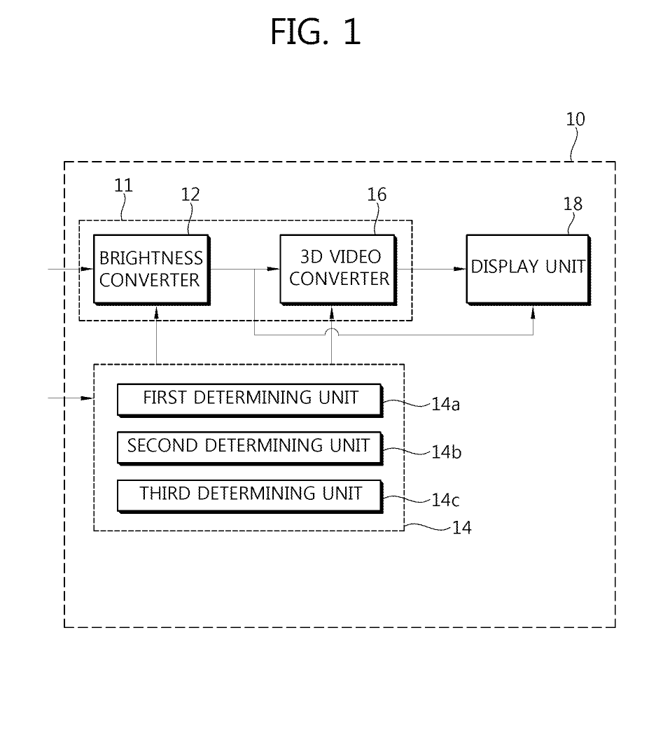

FIG. 1, which is a block diagram showing a configuration of a display device according to a first exemplary embodiment of the present invention, shows a block configuration of a display device for automatically adjusting brightness of a video according to a video mode.

Referring to FIG. 1, a display device 10 according to a first exemplary embodiment of the present invention may receive a video and a video signal including information related to the video from a broadcasting network, a communication network or an external device, determine a video mode of the received video, and convert brightness of the video to be appropriate for the determined video mode. In addition, when the received video is a 3D mode video, the display device 10 may determine a 3D video format of the received video, and convert the brightness-converted video into a 3D video having a format appropriate for a display type based on the determined 3D video format to display the converted 3D video.

The display device 10 may be configured to include a video mode/3D video format determining unit 14, a converting unit 11 and a display unit 18, as shown in FIG. 1. The converting unit 11 may include a brightness converter 12 and a 3D video converter 16.

The video mode/3D video format determining unit 14 may determine a video mode of the received video, that is, an input video. The video mode may be a 2D mode or a 3D mode. That is, the video mode/3D video format determining unit 14 determines whether the received video is a 2D mode video or a 3D mode video. The video mode/3D video format determining unit 14 may transfer information on the determined video mode to the brightness converter 12 of the converting unit 11.

In addition, video mode/3D video format determining unit 14 may also determine the 3D video format of the input video when the input video is the 3D mode video as a result of a video mode determination of the input video. Here, as the 3D video format, there are a frame packing format, a top-and-bottom format, a side-by-side format, a field alternative format, a frame alternative format, a line alternative format, a reference video+depth information format, and the like. Meanwhile, the video mode/3D video format determining unit 14 may transfer information on the determined 3D video format to the 3D video converter 16 of the converting unit 11.

As such, the video mode/3D video format determining unit 14 may serve to determine the video mode and the 3D video format of the input video, and may include a first determining unit 14a, a second determining unit 14b, and a third determining unit 14c.

Although FIG. 1 referred in the present first exemplary embodiment has shown a configuration in which the video mode/3D video format determining unit 14 includes all of the first determining unit 14a, the second determining unit 14b, and the third determining unit 14c for convenience of understanding, the video mode/3D video format determining unit 14 may be implemented in a form in which it includes at least any one of the first determining unit 14a, the second determining unit 14b, and the third determining unit 14c, according to embodiments.

The first determining unit 14a may determine the video mode and the 3D video format by interpreting received 3D signaling information such as the video signal input from the external device. The first determining unit 14a may be used in the case in which the display device 10 receives the video signal from the external device through a high definition multimedia interface (HDMI) supporting 3D signaling. In Version 1.4, etc., of HDMI, the first determining unit 14a may signal whether the video mode is the 2D mode or the 3D mode and may signal what format the 3D video has when the video mode is the 3D mode.

In this case, the first determining unit 14a may determine the video mode of the input video by interpreting an HDMI_Video_Format field of a specific packet, for example, a Vendor Specific InfoFrame packet, in an HDMI signal. When the input video is the 3D mode video, the first determining unit 14a may determine what format the 3D video has by interpreting a 3D_Structure field. That is, the first determining unit 14a determines the 3D video format of the input video.

The second determining unit 14b may determine the video mode and the 3D video format by interpreting 3D signaling information included in a digital broadcasting signal. The second determining unit 14b may be used in the case in which the display device 10 receives the digital broadcasting signal including the 3D signaling information. In digital broadcasting, information on the video mode and the 3D video format may be signaled through at least any one of moving picture experts group (MPEG)-2 program map table (PMT), MPEG-2 user_data and supplemental enhancement information (SEI) of MPEG-4 advanced video coding (AVC). Therefore, in this case, the second determining unit 14b may determine the video mode and the 3D video format of the input video by interpreting at least any one of the MPEG-2 PMT, the MPEG-2 user_data and the SEI of MPEG-4 AVC.

The third determining unit 14c may be used in the case in which the display device 10 receives a video signal without the 3D signaling information. In this case, the third determining unit 14c may provide a user interface through which a user may set the information on the video mode and the 3D video format through the display unit 18, and may determine the video mode and the 3D video format according to the video mode and the 3D video format set through the user interface.

In this case, the user may see the video mode of the video displayed by the display unit 18 with the eyes, and may set the video as the 3D mode video and what format the 3D video has through the user interface, that is, a user menu when the video is the 3D mode video.

For example, when the same video is displayed on each of the left and right sides in a single picture, the video mode is the 3D mode and the 3D video format corresponds to the side-by-side format. Therefore, the user may set the video signal received through the user menu displayed on the display unit 18 as the 3D mode signal and the 3D video format as the side-by-side format. In this case, the third determining unit 14c may determine the video mode and the 3D video format according to the video mode and the 3D video format set by the user.

The brightness converter 12 included in the converting unit 11 automatically converts the brightness of the video to be appropriate for the video mode determined by the video mode/3D format determining unit 14. For example, when the video mode of the input video is the 3D mode, the brightness converter 12 may convert the brightness of the input video into brighter brightness according to preset information. The brightness converter 12 may transfer the brightness-converted video to the 3D video converter 16 of the converting unit 11.

The brightness converter 12 may include a corresponding table containing brightness conversion information corresponding to the video mode. For example, the corresponding table may be setting information on how much is the brightness of the video increased when the input video is the 3D mode video. That is, the corresponding table may include brightness conversion values corresponding to the 3D mode.

Meanwhile, the brightness converter 12 may also convert the brightness of the input video in consideration of setting information of the display unit 18, for example, a display type as well as the video mode. In this case, the corresponding table may include the video mode (2D or 3D), the setting information of the display unit, and the brightness conversion values corresponding thereto, and the brightness converter 12 may convert the brightness according to the setting information of the display unit 18 when the input video is the 2D mode video as well as when it is the 3D mode video.

The 3D video converter 16 of the converting unit 11 may receive the information on the 3D video format of the input video from the video mode/3D video format determining unit 14, and may convert the video brightness-converted by the brightness converter 12 from the received 3D video format into a 3D video format corresponding to the display type of the display unit 18. The 3D video converter 16 may transmit the video of which the format is converted to be appropriate for the display type of the display unit 18 to the display unit 18.

For example, assuming that the 3D video format of the input video is the side-by-side format and the display type of the display unit 18 is a polarizing filter type supporting the line alternative format, the 3D video converter 16 may convert the brightness-converted video having the side-by-side format into a video having the line alternative format to be appropriate for the display unit 18.

On the other hand, assuming that the 3D video format of the input video is the side-by-side format and the display type of the display unit 18 is a shutter glasses type supporting the field alternative format or the frame alternative format, the 3D video converter 16 may convert the brightness-converted video having the side-by-side format into a video having the field alternative format or the frame alternative format to be appropriate for the display unit 18.

Meanwhile, when the input video is the 2D video, it passes through the brightness converter 12 and the 3D video converter 16 to be transferred to the display unit 18 or may be brightness-converted by the brightness converter 12 according to the setting information of the display unit and then, passes through the 3D video converter 16 to be transferred to the display unit.

The display unit 18 may display the video output from the converting unit 11. For example, the display unit 18 may display the 3D mode video output from the 3D video converter 16. Here, the displayed 3D mode video is the video that has been converted by the brightness converter 12 (for example, has been converted to be brighter than the 2D mode video) and has been converted into the 3D video format appropriate for the display type of the display unit 18. Therefore, the user may view the video while having a high satisfaction without feeling that the 3D mode video is darker than the 2D mode video even when he/she views the 3D mode video. Meanwhile, the display unit 18 may display the 2D mode input video or the 2D mode video converted by the brightness converter 12.

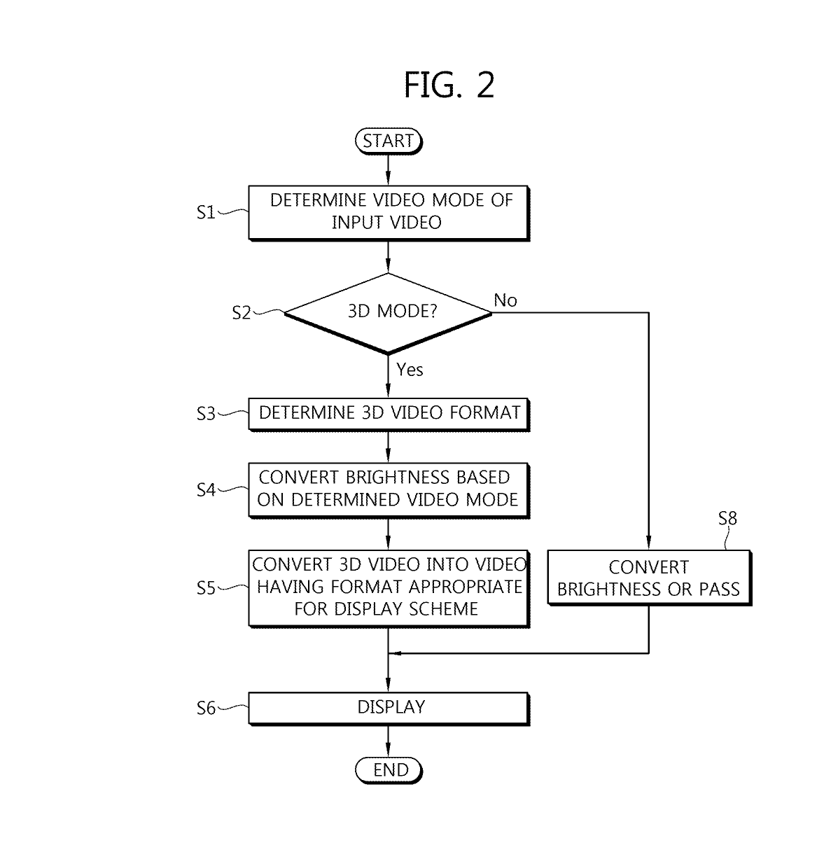

FIG. 2 is a flowchart showing a configuration of a 3D display method according to a first exemplary embodiment of the present invention.

As shown in FIG. 2, the display device 10 first determines the video mode of the input video S1 and S2. For example, the display device determines whether the input video is the 2D mode video or the 3D mode video. When it is determined that the input video is the 3D mode video, the display device determines the 3D video format of the input video S3.

More specifically describing S1 to S3, when the display device 10 receives the video signal from the external device through the HDMI supporting the 3D signaling, it may determine the video mode of the input video by interpreting the HDMI_Video_Format field of the specific packet, for example, the Vendor Specific InfoFrame packet, in the HDMI signal. When it is determined that the input video is the 3D mode video, the display device 10 may determine what format the 3D video has by interpreting the 3D_Structure field.

Alternatively, when the display device 10 receives the digital broadcasting signal including the 3D signaling information, it may determine the video mode and the 3D video format of the input video by interpreting at least any one of the MPEG-2 PMT, the MPEG-2 user_data and the SEI of MPEG-4 AVC of the digital broadcasting signal. Meanwhile, when the display device receives the video signal without the 3D signaling information, it may provide the user interface through which the user may set the information on the video mode and the 3D video format through the display unit 18, and may determine the video mode and the 3D video format according to the video mode and the 3D video format set through the user interface.

Then, the display device 10 converts the brightness of the input video according to the determined video mode S4. For example, when it is determined that the input video is the 3D mode video, the display device 10 may convert the brightness of the input video into the brighter brightness based on the preset information, for example, the corresponding table.

Next, the display device 10 converts the brightness-converted video into the video having the 3D video format corresponding to the display type required by the display unit 18 based on the determined 3D video format of the input video S5. That is, the display device converts the 3D video having the determined 3D video format into the 3D video having the 3D video format appropriate for the display type of the display unit 18. When the format conversion is completed, the display device 10 may display the converted 3D video through the display unit 18 S6.

Meanwhile, in the determination of the video mode S1 and S2, when it is determined that the input video is the 2D mode video, the display device 10 may transmit the input video to the display unit 18 or perform brightness conversion according to the setting information of the display unit 18 S8.

Hereinabove, the display device and the display method according to the first exemplary embodiment of the present invention have been described. With the display device and the display method according to the exemplary embodiment of the present invention, the brightness of the video may be automatically converted according to the video mode, and particularly, the brightness of the video may be automatically converted to be bright in the 3D video mode, such that the user may view the 3D video while having a high satisfaction without a performing separate screen brightness setting.

Meanwhile, although the first exemplary embodiment of the present invention has an example in which when the input video is the 3D mode video, the brightness of the input video is first converted and the brightness-converted input video is converted into the video having the 3D video format appropriate for the display type, a form in which the input video is converted into the video having the 3D video format appropriate for the display type and the brightness of the format-converted video is then converted may also be implemented. Hereinafter, a display device and a display method according to a second exemplary embodiment of the present invention in which the brightness conversion is performed after the 3D video format conversion will be described.

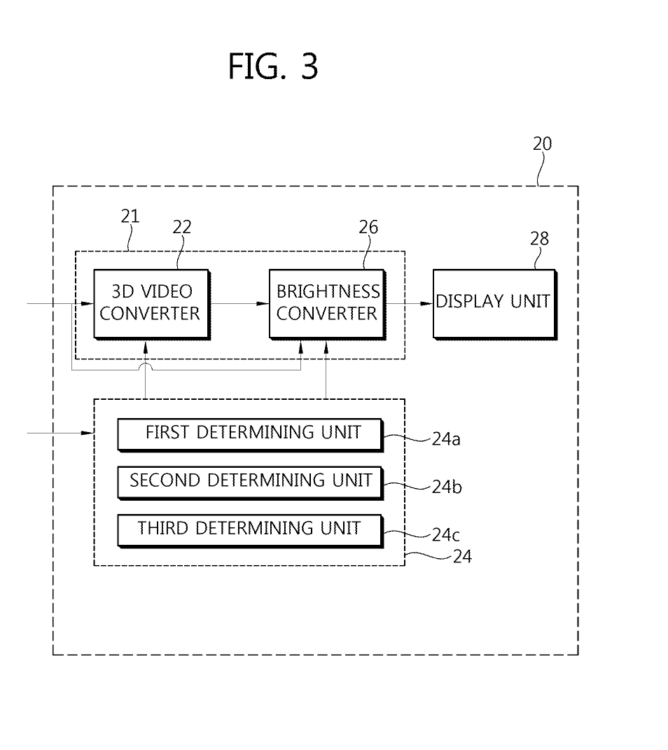

FIG. 3 is a block diagram showing a configuration of a display device 20 according to a second exemplary embodiment of the present invention.

The display device 20 according to a second exemplary embodiment of the present invention may be configured to include a video mode/3D video format determining unit 24, a converting unit 21 and a display unit 28, as shown in FIG. 3. The converting unit 21 may include a 3D video converter 22 and a brightness converter 26. The display device may be the same in basic operations of each component; however, may be changed in configurations of the converting unit 21, that is, processing sequence of the 3D video converter 22 and the brightness converter 26, as compared to the display device according to the first exemplary embodiment of the present invention shown in FIG. 1.

The video mode/3D video format determining unit 24 may perform the same function as that of the video mode/3D video format determining unit 14 described above in the first exemplary embodiment. That is, the video mode/3D video format determining unit 24 determines whether the input video is the 2D mode video or the 3D mode video. The video mode/3D video format determining unit 24 may transfer the information on the determined video mode to the brightness converter 26 of the converting unit 21. In addition, the video mode/3D video format determining unit 24 may determine the 3D video format of the input video to transmit the determined 3D video format to the 3D video converter 22 of the converting unit 21 when the video mode of the input video is the 3D mode.

The video mode/3D video format determining unit 24 may include at least any one of a first determining unit 24a, a second determining unit 24b, and a third determining unit 24c. The first determining unit 24a, the second determining unit 24b, and the third determining unit 24c may perform the same function as those of the first determining unit 14a, the second determining unit 14b, and the third determining unit 14c of FIG. 1 described above in the first exemplary embodiment.

The 3D video converter 22 of the converting unit 21 may receive the information on the 3D video format determined from the video mode/3D video format determining unit 24, and may convert the input video from the determined 3D video format into the 3D video format corresponding to the display type of the display unit 28.

The brightness converter 26 automatically converts the brightness of the input video or the video converted by the 3D video converter 22 to be appropriate for the video mode determined by the video mode/3D video format determining unit 24. For example, when the video mode of the input vide is the 3D mode, the brightness converter 26 may convert the brightness of the video converted by the 3D video converter 22 to be brighter according to the preset information. The brightness converter 26 may transmit the brightness-converted 3D video to the display unit 28. The display unit 28 may display the video transmitted from the brightness converter.

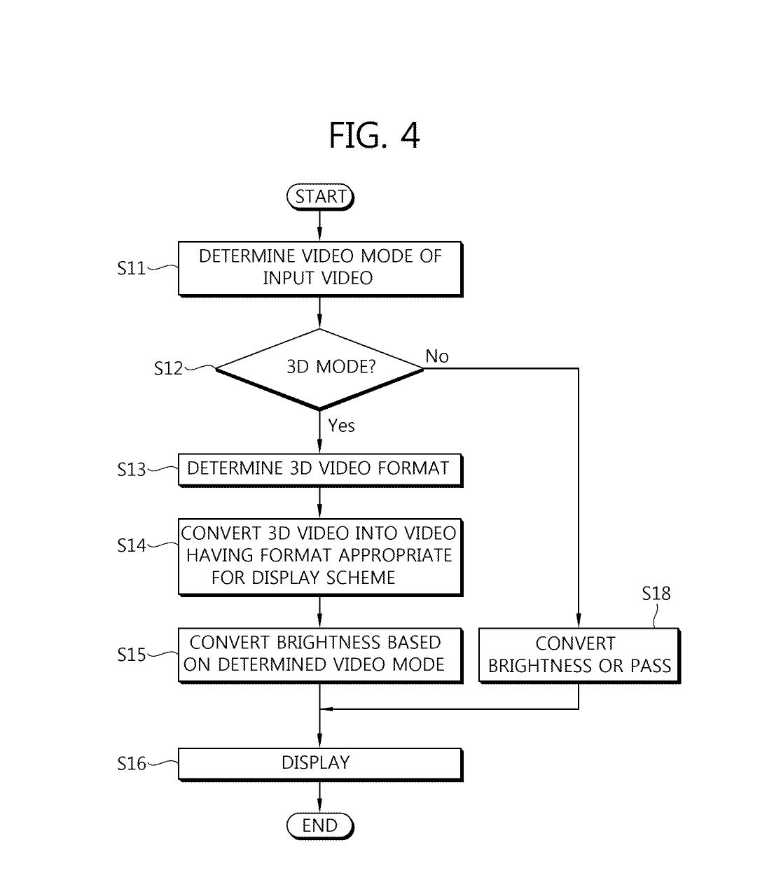

FIG. 4 is a flowchart for describing an operation flow of the display device 20 shown in FIG. 3.

As shown in FIG. 4, the display device 20 first determines the mode of the input video (S11 and S12). For example, the display device 20 determines whether the input video is the 2D mode video or the 3D mode video. When it is determined that the input video is the 3D mode video, the display device 20 determines the 3D video format of the input video (S13).

Next, the display device 20 converts the input video into the video having the 3D video format corresponding to the display type required by the display unit 28 based on the determined 3D video format of the input video (S14). That is, the display device converts the 3D video having the 3D video format into the 3D video having the 3D video format appropriate for the display type of the display unit 28.

Then, the display device 20 converts the brightness of the 3D video converted to be appropriate for the display type according to the determined video mode (S15). That is, the display device may convert the brightness of the converted 3D video to be brighter based on the preset information. Somewhat, the display device 20 may transmit, to the display unit 28, a signal which instructs that the back light of the display unit 28 to be brighter for the brightness of the 3D video to be brighter.

After the brightness conversion is performed, the display device 20 may display the converted 3D video through the display unit 28 (S16). Meanwhile, in the determination of the video mode (S11 and S12), when it is determined that the input video is the 2D mode video, the display device 20 may transmit the input video to the display unit 28 or perform brightness conversion according to the preset setting information of the display unit (S 18).

Although the exemplary embodiments of the present invention have been described, it may be appreciated by those skilled in the art that various modifications and change can be made without departing from the spirit and scope of the appended claims of the present invention. Therefore, the future change in the embodiments of the present invention can not depart from the technology of the present invention.

1. A display device comprising:
a determining unit obtaining information associated with an input video and determining a video mode of the input video based on the obtained information;
a converting unit receiving the input video and automatically converting brightness of the input video according to the video mode determined by the determining unit; and
a display unit displaying a video output from the converting unit.

2. The display device of claim 1, wherein the determining unit determines a 3D video format of the input video based on the obtained information when the video mode of the input video is a 3-dimension (3D) mode.

3. The display device of claim 2, wherein the converting unit includes:
a brightness converter converting the brightness of the input video to be bright based on preset brightness conversion information when it is determined by the determining unit that the video mode of the input video is the 3D mode; and
a 3D video converter converting the input video into a video having a 3D video format corresponding to a display type of the display unit based on the 3D video format of the input video determined by the determining unit.

4. The display device of claim 2, wherein the converting unit includes:
a 3D video converter converting the input video into a video having a 3D video format corresponding to a display type of the display unit based on the 3D video format of the input video determined by the determining unit when it is determined by the determining unit that the video mode of the input video is the 3D mode; and
a brightness converter converting the brightness of the input video converted by the 3D video converter to be bright based on preset brightness conversion information when it is determined by the determining unit that the video mode of the input video is the 3D mode.

5. The display device of claim 2, wherein the converting unit converts the video having the 3D video format determined by the determining unit into a video having a line alternative format when the display type of the display unit is a polarizing filter type.

6. The display device of claim 2, wherein the converting unit converts the video having the 3D video format determined by the determining unit into a video having any one of a field alternative format and a frame alternative format when the display type of the display unit is a shutter glasses type.

7. The display device of claim 1, wherein the determining unit includes at least any one of:
a first determining unit determining the video mode and a 3D video format by interpreting received 3D signaling information such as a video signal input from an external device;
a second determining unit determining the video mode and the 3D video format by interpreting 3D signaling information included in a digital broadcasting signal; and
a third determining unit determining the video mode and the 3D video format according to information input from a user interface.

8. The display device of claim 7, wherein the first determining unit determines the video mode of the input video by interpreting an ‘HDMI Video Format’ field of a ‘Vendor Specific InfoFrame’ packet included in a high definition multimedia interface (HDMI) signal, and determines the 3D video format of the input video by interpreting a ‘3D_Structure’ field when the input video is the 3D mode video.

9. The display device of claim 7, wherein the second determining unit determines the video mode and the 3D video format of the input video by interpreting information on a video mode and a 3D video format included in program map table (PMT) of the digital broadcasting signal.

10. The display device of claim 7, wherein the second determining unit determines the video mode and the 3D video format of the input video by interpreting information on a video mode and a 3D video format included in ‘user_data’ of the digital broadcasting signal.

11. The display device of claim 7, wherein the second determining unit determines the video mode and the 3D video format of the input video by interpreting information on a video mode and a 3D video format included in supplemental enhancement information (SEI) of the digital broadcasting signal.

12. A display method comprising:
obtaining information associated with an input video;
determining a video mode of the input video based on the obtained information;
automatically converting brightness of the input video according to the determined video mode; and
displaying a display video based on the brightness-converted video.

13. The display method of claim 12, further comprising determining a 3D video format of the input video based on the obtained information when it is determined that the video mode of the input video is a 3D mode at the determining.

14. The display method of claim 13, further comprising converting the input video into a video having a 3D video format corresponding to a display type of the display unit based on the determined 3D video format of the input video,
wherein the automatic converting of the brightness of the input video includes: converting the brightness of the input video to be bright based on preset brightness conversion information when it is determined that the video mode of the input video is the 3D mode at the determining.

15. The display method of claim 13, further comprising converting the input video into a video having a 3D video format corresponding to a display type of the display unit based on the determined 3D video format of the input video when it is determined that the video mode of the input video is the 3D mode at the determining,
wherein the automatic converting of the brightness of the input video includes: converting the brightness of the input video converted into the video having the 3D video format corresponding to the display type to be bright based on preset brightness conversion information.

16. The display method of claim 12, wherein the determining includes at least any one of:
determining the video mode and a 3D video format by interpreting received 3D signaling information such as a video signal input from an external device;
determining the video mode and the 3D video format by interpreting 3D signaling information included in a digital broadcasting signal; and
determining the video mode and the 3D video format according to information input from a user interface.

17. The display method of claim 16, wherein the determining of the video mode and the 3D video format by interpreting the received 3D signaling information such as the video signal input from the external device includes:
determining the video mode of the input video by interpreting an ‘HDMI Video Format’ field of a ‘Vendor Specific InfoFrame’ packet included in an HDMI signal; and
determining the 3D video format of the input video by interpreting a ‘3D_Structure’ field when the input video is the 3D mode video.

18. The display method of claim 16, wherein the determining of the video mode and the 3D video format by interpreting the 3D signaling information included in the digital broadcasting signal includes: determining the video mode and the 3D video format of the input video by interpreting information on a video mode and a 3D video format included in program map table (PMT) of the digital broadcasting signal.

19. The display method of claim 16, wherein the determining of the video mode and the 3D video format by interpreting the 3D signaling information included in the digital broadcasting signal includes: determining the video mode and the 3D video format of the input video by interpreting information on a video mode and a 3D video format included in ‘user_data’ of the digital broadcasting signal.

20. The display method of claim 16, wherein the determining of the video mode and the 3D video format by interpreting the 3D signaling information included in the digital broadcasting signal includes: determining the video mode and the 3D video format of the input video by interpreting information on a video mode and a 3D video format included in SEI of the digital broadcasting signal.
